(19) United States
(12) Patent Application Publication
(10) Pub. No.: US 2021/0061683 A1
(43) Pub. Date: Mar. 4, 2021

(54) SELECTIVE REMOVAL OF SCALE-FORMING IONS FOR WATER SOFTENING

(71) Applicant: LAWRENCE LIVERMORE NATIONAL SECURITY, LLC, Livermore, CA (US)

(72) Inventors: Patrick G. Campbell, Oakland, CA (US); Maira R. Cerón Hernández, Brentwood, CA (US); Steven A. Hawks, Livermore, CA (US); Tuan Anh Pham, Livermore, CA (US); Michael Stadermann, Pleasanton, CA (US)

(21) Appl. No.: 16/929,445

(22) Filed: Jul. 15, 2020

Related U.S. Application Data
(60) Provisional application No. 62/893,986, filed on Aug. 30, 2019.

(51) Int. Cl. C02F 1/469; C02F 1/46; C02F 5/00

(52) U.S. Cl. CPC C02F 1/4691; C02F 2101/10; C02F 5/00; C02F 1/4602

(57) ABSTRACT

Use of porous carbon aerogel materials as capacitive deionization (CDI) electrodes to selectively remove scale forming divalent ions (e.g., Mg, Ca) from “hard” waters. A first electrode and/or a second electrode are made from activated carbon with graphite current collectors. A non-conductive, electrolyte permeable paper or polymer membrane separator is sandwiched between the first electrode and the second electrode.

### STATEMENT AS TO RIGHTS TO APPLICATIONS MADE UNDER FEDERALLY SPONSORED RESEARCH AND DEVELOPMENT

The United States Government has rights in this application pursuant to Contract No. DE-AC52-07NA27344 between the United States Department of Energy and Lawrence Livermore National Security, LLC for the operation of Lawrence Livermore National Laboratory.

### BACKGROUND

### Field of Endeavor

The present application relates to water softening and more particularly to water softening using flow through electrode capacitive deionization with carbon aerogel electrodes having optimal pore size distribution.

### State of Technology

This section provides background information related to the present disclosure which is not necessarily prior art.

The current state of the art for water softening is ion exchange in columns packed with functionalized resin. The resins work by adsorbing scale forming ions (Ca, Mg) and replacing them with Na, adding sodium to the softened water. These resins must be periodically regenerated using large amounts of salt (NaCl), which is a consumable chemical that must be purchased and also introduces a high salt load into municipal sewer systems and water treatment plants.

An alternative is to use water desalination technology, such as reverse osmosis (RO). Reverse osmosis uses membranes that allow water, but not salt, to pass through membranes. Pressure is applied to the feed side, pushing water across the membrane to overcome membrane resistance, as well as the osmotic pressure. However, RO membranes are non-selective, which means that one must remove all ions to remove a particular contaminant. This further reduces the possible efficiency of using RO to treat water for specific trace contaminants such as Mg and Ca. In addition, it may not be desirable to remove all ionic species as usually some amount of hardness is favorable or, for example, a small amount of fluoride is desired for health reasons.

Capacitive deionization (CDI) is a more recent technology. Unlike membrane-based methods, CDI removes salt with electric fields. The charged salt ions are attracted to the charged porous electrodes and thus removed from the water. The device is operated by applying a voltage between the two electrodes, which act like plates of a supercapacitor, while water passes through the device to remove the salt from the feed water. The energy cost of CDI scales with the amount of salt removed, thus giving it the potential to be more energy efficient than RO in low salinity regimes. Because CDI is an inherently low-pressure operation made from low-cost materials, the capital costs are also expected to be significantly less than RO. Finally, CDI is highly tunable in terms of the product-water salinity whereas RO is not.

### SUMMARY

Features and advantages of the disclosed apparatus, systems, and methods will become apparent from the following description. Applicant is providing this description, which includes drawings and examples of specific embodiments, to give a broad representation of the apparatus, systems, and methods. Various changes and modifications within the spirit and scope of the application will become apparent to those skilled in the art from this description and by practice of the apparatus, systems, and methods. The scope of the apparatus, systems, and methods is not intended to be limited to the particular forms disclosed and the application covers all modifications, equivalents, and alternatives falling within the spirit and scope of the apparatus, systems, and methods as defined by the claims.

Applicant's apparatus, systems, and methods provide water softening, by providing a first electrode conductor having first pores, providing a second electrode conductor having second pores, providing a separator, sandwiching said separator between said first electrode conductor and said second electrode conductor, providing headers around said first electrode conductor and said second electrode conductor, and providing channels that direct the water to said first electrode conductor and said second electrode conductor. In one embodiment of Applicant's apparatus, systems, and methods said first electrode conductor is made of activated hierarchical carbon aerogel material. In another embodiment of Applicant's apparatus, systems, and methods said second electrode conductor is made of activated hierarchical carbon aerogel material. In yet another embodiment of Applicant's apparatus, systems, and methods said first electrode conductor is made of activated hierarchical carbon aerogel material with graphite current collectors. In another embodiment of Applicant's apparatus, systems, and methods said first electrode conductor is made of activated hierarchical carbon aerogel material with graphite current collectors. In another embodiment of Applicant's apparatus, systems, and methods said first electrode conductor is a hierarchical carbon aerogel monolith.

Applicant's apparatus, systems, and methods have uses in hardness removal, scale reduction, heat exchangers, water treatment, commercial and residential water softening.

The apparatus, systems, and methods are susceptible to modifications and alternative forms. Specific embodiments are shown by way of example. It is to be understood that the apparatus, systems, and methods are not limited to the particular forms disclosed. The apparatus, systems, and methods cover all modifications, equivalents, and alternatives falling within the spirit and scope of the application as defined by the claims.

### BRIEF DESCRIPTION OF THE DRAWINGS

The accompanying drawings, which are incorporated into and constitute a part of the specification, illustrate specific embodiments of the apparatus, systems, and methods and, together with the general description given above, and the detailed description of the specific embodiments, serve to explain the principles of the apparatus, systems, and methods.

FIG. 1 illustrates one embodiment of the inventor's apparatus, systems, and methods.

FIG. 2 illustrates another embodiment of the inventor's apparatus, systems, and methods.

FIG. 3 illustrates yet another embodiment of the inventor's apparatus, systems, and methods.

### DETAILED DESCRIPTION OF SPECIFIC EMBODIMENTS

Referring to the drawings, to the following detailed description, and to incorporated materials, detailed information about the apparatus, systems, and methods is provided including the description of specific embodiments. The detailed description serves to explain the principles of the apparatus, systems, and methods. The apparatus, systems, and methods are susceptible to modifications and alternative forms. The application is not limited to the particular forms disclosed. The application covers all modifications, equivalents, and alternatives falling within the spirit and scope of the apparatus, systems, and methods as defined by the claims.

This application describes the use of porous carbon aerogel materials as capacitive deionization (CDI) electrodes to selectively remove scale forming divalent ions (e.g., Mg, Ca) from “hard” water. Through control of the activation percentage of the electrode material, the inventors achieve both a high sorption capacity and a micropore-size distribution with pores size distribution suited for adsorbing divalent cations. The inventors have reduced this idea to practice by measuring an adsorption selectivity of calcium over sodium (selectivity Ca/Na=6.6) when performing a constant voltage charge of the fteCDI device at 0.6 V on a mixture of Ca/Na ions in deionized water. The selectivity can be reversed to favor monovalent ions over divalent ions by reducing the activation percentage of the electrodes; moderate activation (slit pores <1 nm) yields adsorption/removal of only monovalent sodium ions with very high selectivity over the divalent calcium ions.

The cell consists of one or multiple pairs of electrodes made from activated hierarchical carbon aerogel monoliths (HCAM) with graphite current collectors, separated by non-conductive polyester membranes. To form the final device for selectively removing divalent ions, the electrodes are sandwiched between header plates made of UV transparent acrylic material, which provide structural support to the electrodes and which have machined (or laser etched) channels for electrolyte/salt water flow facing the electrodes.

In previous iterations of this technology, the inventors produced ‘ultramicroporous’ electrode (16-18% activated, which means that the micropore size distribution of the electrodes was almost entirely below 1 nm in width. These ultramicropores are perfectly sized to selectively adsorb nitrate over other ions (such as chloride) and completely reject both divalent anions like sulfate, and divalent cations like magnesium and calcium. In this application, the inventors have increased the activation of the carbon electrodes, which leads to a micropore-size distribution with bigger pores suited for adsorbing the divalent ions (23-28% activated, best results are with materials with >30% activation). Since the larger ions can now enter the pores, and because they have a higher charge (+2 vs +1, for example), the electrostatic interaction between divalent ions and the charge electrode are stronger leading to selectivity for divalents over monovalents. Moreover, by tuning the pore size to fit divalent ions specifically, the interaction between the pore wall (electrode) and ion is enhanced, leading to greater charge transfer between the electrode and ion, increasing binding strength and selectivity. The enhanced selectivity through charge transfer has been recently predicted by advanced theoretical modeling, and the results for monovalent cations. The selectivity for Ca over Na has been reduced to practice. The inventors built CDI cells using more highly activated HCAM electrodes and observed a selectivity factor for Ca over Na of 6.6.

This value will increase significantly by optimizing the pore size distribution as well as the operating mode of CDI device (e.g., charge voltage, flow rate, charging method, etc). Electrode Material Ultramicroporous hierarchical carbon aerogel monoliths (μECAMs) were synthesized by dissolving 430.5 g of resorcinol (3.92 mol, 99% Sigma Aldrich) in 525.0 g of DI water. 626.5 g of 37% formaldehyde solution (7.84 mol, ACS grade, contains 10% MeOH, Sigma Aldrich) was then added, followed by 15.4 g of glacial acetic acid (0.245 mol, 99+% Sigma Aldrich). The reagents are mixed for 30 min at 40° C. before being poured into a Teflon mold and cured at 23° C. for 46 h, followed by ageing for 24 h at 70° C. Aged resorcinol-formaldehyde (RF) blocks are then removed from the mold and sliced into thin, 500±100 μm, sheets with a band saw (Delta 28-185). Wet organic aerogel sheets are washed with DI water and subsequently exchanged for acetone. Wet aerogel sheets are sandwiched between porous silicon carbide sheets and then loaded into a custom-made drying chamber equipped with an airflow control unit. After loading, the box is sealed, and the air flow rate is set to 80 mL/min. Dry carbon aerogel were carbonized at 950° C. for 3 h under N₂. The sample was subsequently activated with CO₂ flow at 2 L/min in a 6-inch tube furnace for 1 h and 3 h at 950° C. to obtain “low” activated (16-18% mass loss during activation) and “high” activated (34-38% mass loss during activation) HCAM, respectively.

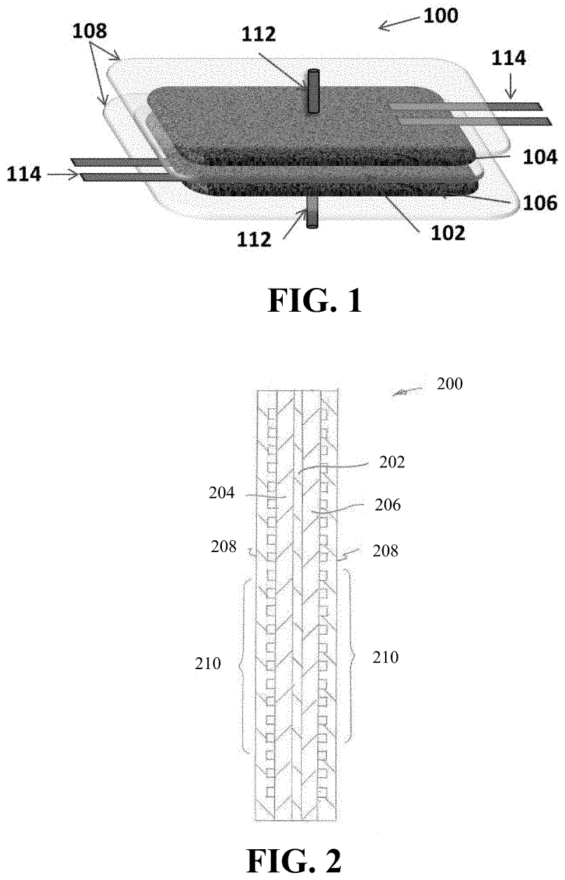

Referring now to the drawings, and in particular to FIG. 1, a simplified schematic depiction illustrates a first embodiment of the inventor's apparatus, systems, and methods. As illustrated, the first embodiment includes a number of components. The components of the inventor's apparatus, systems, and methods illustrated in FIG. 1 are identified and described below.
Reference Numeral 100—cell,
Reference Numeral 102—porous membrane separator, Reference Numeral 104—first electrode,
Reference Numeral 106—second electrode, Reference Numeral 108—header plate(s).
Reference Numeral 112—fluid ports
Reference Numeral 114—current collectors

The identification and description of the components illustrated in FIG. 1 having been completed, the operation and additional description of the inventor's apparatus, systems, and methods will now be considered in greater detail.

The cell 100 comprises a first electrode 104 and a second electrode 106. The first electrode 104 and the second electrode 106 are separated by a separator 102. The first electrode 104, the second electrode 106, and the separator 102 are sandwiched between header plates 108.

The first electrode 104 and the second electrode 106 are made from activated hierarchical carbon aerogel material (HCAM) with graphite current collectors. The separator 102 is a non-conductive electrolyte permeable paper or polymer material. The header plate 108 is made of UV transparent acrylic material.

The Electrode Material

At least one of the first electrode 104 and the second electrode 106 are ultramicroporous hierarchical carbon aerogel monoliths (μHCAMs) that were synthesized by dissolving 430.5 g of resorcinol (3.92 mol, 99% Sigma Aldrich) in 525.0 g of DI water. 626.5 g of 37% formaldehyde solution (7.84 mol, ACS grade, contains 10% MeOH, Sigma Aldrich) was then added, followed by 15.4 g of glacial acetic acid (0.245 mol, 99+% Sigma Aldrich). The reagents are mixed for 30 min at 40° C. before being poured into a Teflon mold and cured at 23° C. for 46 h, followed by ageing for 24 h at 70° C. Aged RF blocks are then removed from the mold and sliced into thin, 500±100 μm, sheets with a band saw (Delta 28-185). Wet organic aerogel sheets are washed with DI water and subsequently exchanged for acetone. Wet aerogel sheets are sandwiched between porous silicon carbide sheets and then loaded into a custom-made drying chamber equipped with an airflow control unit. After loading, the box is sealed, and the air flow rate is set to 80 mL/min. Dry carbon aerogel were carbonized at 950° C. for 3 h under N₂. The sample was subsequently activated with CO₂ flow at 2 L/min in a 6-inch tube furnace for 1 h and 3 h at 950° C. to obtain “low” activated (16-18% mass loss during activation) and “high” activated (34-38% mass loss during activation) HCAM, respectively.

FIG. 2 illustrates another embodiment of the inventor's apparatus, systems, and methods. The components illustrated in FIG. 2 are identified and described below.
Reference Numeral 200—cell,
Reference Numeral 202—porous inert separator,
Reference Numeral 104—first electrode,
Reference Numeral 106—second electrode,
Reference Numeral 108—header plate(s), and
Reference Numeral 110—channels.

The identification and description of the components illustrated in FIG. 2 having been completed, the operation and additional description of the inventor's apparatus, systems, and methods will now be considered in greater detail. To form the final device for selectively removing divalent ions, the electrodes 204 and 206 are sandwiched between the header plates 208 made of UV transparent acrylic material, which provide structural support to the electrodes 204 and 206 and which have machined (or laser etched) channels 210 for electrolyte/salt water flow facing the electrodes 204 and 206.

The cell 200 uses porous carbon aerogel materials as capacitive deionization (CDI) electrodes to selectively remove scale forming divalent ions (e.g., Mg, Ca) from “hard” water. Through control of electrode material activation parameters, the inventors achieve both a high sorption capacity and a micropore-size distribution with pores size distribution suited for adsorbing divalent cations. The inventors have reduced their apparatus, systems, and methods to practice by measuring an adsorption selectivity of calcium over sodium (selectivity Ca/Na=6.6) when performing a constant voltage charge of the fteCDI device at 0.6 V on a mixture of Ca/Na ions in deionized water. The selectivity can be reversed to favor monovalent ions over divalent ions by reducing the activation percentage of the electrodes; moderate activation (slit pores <1 nm) yields adsorption/removal of only monovalent sodium ions with very high selectivity over the divalent calcium ions.

In previous iterations, the inventors produced “ultramicroporous” electrode (16-18% activated), which means that the micropore size distribution of the electrodes was almost entirely below 1 nm in width, and majority of those pores were <6 nm. The ultramicropores are perfectly sized to selectively adsorb nitrate over other ions (such as chloride) and completely reject both divalent anions like sulfate, and divalent cations like magnesium and calcium. The inventors have increased the activation of the carbon electrodes, which leads to a micropore-size distribution with bigger pores suited for adsorbing the divalent ions (23-28% activated, FIG. 1, best results are with materials with >30% activation). Since the larger ions can now enter the pores, and because they have a higher charge (+2 vs+1), the electrostatic interaction between divalent ions and the charge electrode are stronger leading to selectivity for divalents over monovalents. Moreover, by tuning the pore size to fit divalent ions specifically, the interaction between the pore wall (electrode) and ion is enhanced, leading to greater charge transfer between the electrode and ion, increasing binding strength and selectivity. The enhanced selectivity through charge transfer has been recently predicted by advanced theoretical modeling. The selectivity for Ca over Na has been reduced to practice. The inventors built fteCDI cells using more highly activated HCAM electrodes and observed a selectivity factor for Ca over Na of 6.6. This will increase this value significantly by optimizing the pore size distribution as well as the operating mode of CDI device (e.g., charge voltage, flow rate, CC vs CV, etc).

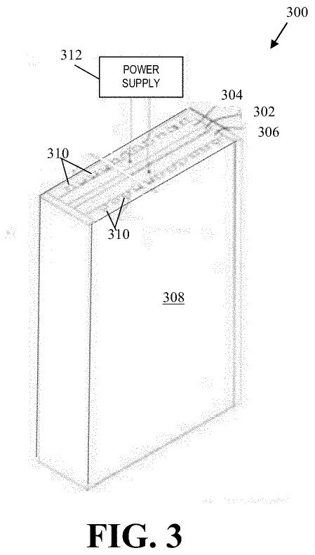

Referring now to FIG. 3, a simplified schematic depiction illustrates a cell unit of Applicant's apparatus, systems, and methods. The cell unit can be ganged with identical additional cell units. The cell unit comprises a first electrode 304 and a second electrode 306. The first electrode 304 and the second electrode 306 are separated by a separator 302. The electrodes 304 and 306 are sandwiched between the header plates 308 made of UV transparent acrylic material, which provide structural support to the electrodes 304 and 306 and which have machined (or laser etched) channels 310 for electrolyte/salt water flow facing the electrodes 304 and 306.

Although the description above contains many details and specifics, these should not be construed as limiting the scope of the application but as merely providing illustrations of some of the presently preferred embodiments of the apparatus, systems, and methods. Other implementations, enhancements and variations can be made based on what is described and illustrated in this patent document. The features of the embodiments described herein may be combined in all possible combinations of methods, apparatus, modules, systems, and computer program products. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination. Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described above should not be understood as requiring such separation in all embodiments.

Therefore, it will be appreciated that the scope of the present application fully encompasses other embodiments which may become obvious to those skilled in the art. In the claims, reference to an element in the singular is not intended to mean “one and only one” unless explicitly so stated, but rather “one or more.” All structural and functional equivalents to the elements of the above-described preferred embodiment that are known to those of ordinary skill in the art are expressly incorporated herein by reference and are intended to be encompassed by the present claims. Moreover, it is not necessary for a device to address each and every problem sought to be solved by the present apparatus, systems, and methods, for it to be encompassed by the present claims.

Furthermore, no element or component in the present disclosure is intended to be dedicated to the public regardless of whether the element or component is explicitly recited in the claims. No claim element herein is to be construed under the provisions of 35 U.S.C. 112, sixth paragraph, unless the element is expressly recited using the phrase “means for.”

While the apparatus, systems, and methods may be susceptible to various modifications and alternative forms, specific embodiments have been shown by way of example in the drawings and have been described in detail herein. However, it should be understood that the application is not intended to be limited to the particular forms disclosed. Rather, the application is to cover all modifications, equivalents, and alternatives falling within the spirit and scope of the application as defined by the following appended claims.

1. Apparatus for water softening, comprising:
a first electrode conductor having first pores;
a second electrode conductor having second pores;
a separator between said first electrode conductor having first pores and said second electrode conductor having second pores,
a voltage system for applying a voltage to said first electrode conductor and said second electrode conductor; and
channels for directing the water into said first pores said second pores.

2. The apparatus for water softening of claim 1 wherein said first electrode conductor is made of activated carbon.

3. The apparatus for water softening of claim 1 wherein said first electrode conductor is made of activated hierarchical carbon aerogel material.

4. The apparatus for water softening of claim 1 wherein said first electrode conductor is made of activated hierarchical carbon aerogel monoliths.

5. The apparatus for water softening of claim 1 wherein said second electrode conductor is made of activated hierarchical carbon aerogel material.

6. The apparatus for water softening of claim 1 wherein said first electrode conductor is made of activated hierarchical carbon aerogel material with graphite current collectors.

7. The apparatus for water softening of claim 1 wherein said first electrode conductor is made of activated hierarchical carbon aerogel material with graphite current collectors.

8. The apparatus for water softening of claim 1 wherein said first electrode conductor is a hierarchical carbon aerogel monolith.

9. The apparatus for water softening of claim 1 wherein said separator is a non-conductive, electrolyte permeable paper or polymer material.

10. The apparatus for water softening of claim 1 further comprising header plates wherein said first electrode and said second electrode are sandwiched between said header plates.

11. A method of water softening, comprising the steps of:
providing a first electrode conductor having first pores,
providing a second electrode conductor having second pores,
providing a separator,
sandwiching said separator between said first electrode conductor and said second electrode conductor,
providing headers around said first electrode conductor and said second electrode conductor, and
providing channels that direct the water to said first electrode conductor and said second electrode conductor.

12. The method of water softening of claim 11 wherein said first electrode conductor is made of activated hierarchical carbon aerogel material.

13. The method of water softening of claim 11 wherein said second electrode conductor is made of activated hierarchical carbon aerogel material.

14. The method of water softening of claim 11 wherein said first electrode conductor is made of activated hierarchical carbon aerogel material with graphite current collectors.

15. The method of water softening of claim 11 wherein said first electrode conductor is made of activated hierarchical carbon aerogel material with graphite current collectors.

16. The method of water softening of claim 11 wherein said first electrode conductor is a hierarchical carbon aerogel monolith.

17. The method of water softening of claim 11 wherein said second electrode conductor is a hierarchical carbon aerogel monolith.

18. The method of water softening of claim 11 wherein said separator is a non-conductive, electrolyte permeable paper or polymer material.

19. The method of water softening of claim 11 further comprising header plates wherein said first electrode and said second electrode are sandwiched between said header plates.

20. Apparatus, systems, and methods for water softening, comprising:
use of porous carbon aerogel materials as capacitive deionization (CDI) electrodes to selectively remove scale forming divalent ions (e.g., Mg, Ca) from “hard” waters.
